(19) United States
(12) Patent Application Publication
(10) Pub. No.: US 2026/0355549 A1
(43) Pub. Date: Nov. 12, 2026

(54) Pressurisation Cycle Counter

(71) Applicant: Dräger Safety AG & Co. KGaA, Lübeck (DE)

(72) Inventors: Emilie Lageat, Morpeth (GB); James Farnaby, Gosforth (GB)

(21) Appl. No.: 19/556,047

(22) Filed: Mar. 4, 2026

(30) Foreign Application Priority Data
May 7, 2025 (EP) 25174875.2

(51) Int. Cl. A62B 9/00

(52) U.S. Cl. CPC A62B 9/006

(57) ABSTRACT

A cycle counter configured to measure pressure cycles within a breathing circuit of a self-contained breathing apparatus, the breathing circuit being configured to operate at a nominal pressure, the cycle counter comprising: a piston having a first side exposed to a true pressure in the breathing circuit and a second side exposed to an ambient pressure; a biasing element configured to: permit the piston to move from a minimum displacement to a maximum displacement when the true pressure exceeds a threshold; and return the piston from the maximum displacement to the minimum displacement when the true pressure falls below the threshold; wherein the threshold is a majority proportion of the nominal pressure; and an indicator configured to increment a counter each time the piston cycles between the minimum displacement and the maximum displacement. Also disclosed is a breathing circuit and a breathing apparatus.

### CROSS-REFERENCE TO RELATED APPLICATIONS

This application claims priority to European Application No. 25 174 875.2, filed on May 7, 2025 and entitled “Pressurisation Cycle Counter” the entirety of which is hereby incorporated by reference in its entirety for all non-limiting purposes.

### TECHNICAL FIELD

The present disclosure relates to a pressure cycle counter for a breathing apparatus and, more specifically, to a medium-pressure cycle counter configured to measure pressure cycles within a medium-pressure breathing circuit of a self-contained breathing apparatus.

### BACKGROUND

Firefighters and other emergency personnel are regularly faced with responding to incidents in challenging and often dangerous environments. These environments are often categorised as immediately dangerous to life or health (IDLH). IDLH environments may include environments with toxic or harmful gases or particulates (such as smoke) which, if inhaled, could lead to sickness or death. In order to operate in IDLH environments, firefighters use breathing apparatus systems such as self-contained breathing apparatus (SCBA) system. These systems provide the user with safe, breathable gas on demand from a compressed gas supply, so that they are not at risk of breathing in any harmful environmental components.

The equipment used in such systems must be regularly maintained to ensure that it functions safely and reliably. Generally, systems are currently inspected and serviced after a specified period of time and/or after a specified number of uses, depending on the manufacturer’s guidance. These methods require manual and time consuming logging of service events, which can lead to inaccuracies – potentially resulting in inspections and services not being carried out in a timely manner.

It will therefore be appreciated that improvements in indicating when a system should be inspected and/or serviced would be desirable.

### SUMMARY

Various aspects of the disclosure will now be described.

According to a first aspect, there is provided a cycle counter. The cycle counter may be configured to measure pressure cycles within a breathing circuit of a self-contained breathing apparatus. The breathing circuit may be configured to operate at a nominal pressure. The cycle counter may comprise: a piston having a first side exposed to a true pressure in the breathing circuit and a second side exposed to an ambient pressure; a biasing element configured to: permit the piston to move from a minimum displacement to a maximum displacement when the true pressure exceeds a threshold; and return the piston from the maximum displacement to the minimum displacement when the true pressure falls below the threshold; wherein the threshold is a majority proportion of the nominal pressure; and an indicator configured to increment a counter each time the piston cycles between the minimum displacement and the maximum displacement.

The cycle counter may be a medium-pressure cycle counter, and the breathing circuit may be a medium-pressure breathing circuit.

Thus, according to a second aspect, there is provided a medium-pressure cycle counter configured to measure pressure cycles within a medium-pressure breathing circuit of a self-contained breathing apparatus. The medium-pressure breathing circuit may be configured to operate at a nominal pressure. The medium-pressure cycle counter may comprise: a piston having a first side exposed to a true pressure in the medium-pressure breathing circuit and a second side exposed to an ambient pressure; a biasing element configured to: permit the piston to move from a minimum displacement to a maximum displacement when the true pressure exceeds a threshold; and return the piston from the maximum displacement to the minimum displacement when the true pressure falls below the threshold; wherein the threshold is a majority proportion of the nominal pressure; and an indicator configured to increment a counter each time the piston cycles between the minimum displacement and the maximum displacement.

The cycle counter may be a high-pressure cycle counter. The breathing circuit may be a high-pressure breathing circuit.

Thus, according to a third aspect, there is provided a high-pressure cycle counter configured to measure pressure cycles within a high-pressure breathing circuit of a self-contained breathing apparatus. The high-pressure breathing circuit may be configured to operate at a nominal pressure. The high-pressure cycle counter may comprise: a piston having a first side exposed to a true pressure in the high-pressure breathing circuit and a second side exposed to an ambient pressure; a biasing element configured to: permit the piston to move from a minimum displacement to a maximum displacement when the true pressure exceeds a threshold; and return the piston from the maximum displacement to the minimum displacement when the true pressure falls below the threshold; wherein the threshold is a majority proportion of the nominal pressure; and an indicator configured to increment a counter each time the piston cycles between the minimum displacement and the maximum displacement.

In the context of self-contained breathing apparatus, it will be appreciated that breathing gas from a high-pressure source, such as a gas cylinder, is expanded in two stages down to a breathable pressure and then delivered to the user to breathe. Consequently, “medium pressure” and “high pressure” are terms of art which are well understood in the field of breathing apparatus. In the case of “medium pressure”, this term is used to refer to a portion of the breathing system which operates at an intermediate pressure between other portions of the breathing system which operate at a high pressure and a low pressure, respectively. In the case of “high pressure”, this term is used to refer to a portion of the breathing system which operates at a high pressure before (i.e., upstream of) other portions of the breathing system.

The parts of a breathing apparatus which direct the flow of supplied breathing gas to, and sometimes from, the user are together known as the breathing circuit. Breathing circuits may be open, closed, or semi-closed, depending on whether breathing gas is recycled. It is only in the case of closed systems where the breathed gas completes a full circuit (i.e., returns back to its origin). Breathing apparatus are routinely classified as "open circuit" when there is no recycling of exhaled gas, and therefore no complete circuit in the more general sense.

The portion of the breathing circuit between the gas source and the first stage pressure reducer may be known as the high-pressure circuit, as it contains the highest pressure gas in the system. The portion of the breathing circuit between the first stage pressure reducer and the second stage pressure reducer (e.g., a lung demand valve/regulator) may be known as the medium pressure circuit, as it contains gas that has been expanded down to an intermediate pressure. The portion of the breathing circuit downstream of the second stage pressure reducer may be known as the low-pressure circuit, as it contains the lowest pressure gas in the system.

In terms of absolute pressure values, a high pressure in this context may generally be several hundred bar, for example between 300 bar and 400 bar. Where the breathing gas source is a breathing gas cylinder, the high pressure circuit’s true pressure will reduce over time as breathing gas is consumed. Over time, the high pressure may reduce from over 300 bar at its maximum to around 20 bar at its minimum. A low pressure in this context may generally be a pressure breathable by a user, for example around atmospheric pressure or slightly above (e.g., 1 bar). A medium pressure in this context may be between 5 bar and 10 bar, for example 6 bar, 7 bar or 8 bar.

The term “breathing circuit” will be understood to refer to one or more components of a breathing apparatus that function with a working fluid (e.g., breathing gas). Generally, a breathing circuit may begin at a pressurised breathing gas tank, which feeds high pressure breathing gas to a first stage pressure reducer. The first stage pressure reducer may reduce the high pressure breathing gas to medium pressure breathing gas. The breathing circuit may also include a second stage pressure reducer (e.g., a lung demand regulator) where pressure of the medium-pressure breathing gas is further reduced to a breathable pressure (i.e., a low pressure).

It follows that the term “medium-pressure breathing circuit” will be understood to refer to one or more components of a breathing apparatus that function with a working fluid (e.g., breathing gas) at a medium pressure. Generally, a medium-pressure breathing circuit may begin at a first stage pressure reducer which reduces high pressure breathing gas to medium pressure breathing gas. A medium-pressure breathing circuit may end at a second stage pressure reducer (e.g., a lung demand regulator) where pressure of the breathing gas is further reduced to a breathable pressure. Thus, a “medium-pressure breathing circuit” may be regarded as encompassing the pneumatics equipment connected between the first stage pressure reducer and the second stage pressure reducer.

It will be understood that an “ambient pressure” may be a pressure of the atmosphere in the environment in which the cycle counter (e.g., the medium-pressure cycle counter) is used.

It will be understood that a “nominal pressure” may be an expected or design pressure of the breathing circuit (e.g., the medium-pressure breathing circuit). The nominal pressure may differ from the true or working pressure of the breathing circuit, for example due transient variations in pressure caused by a user breathing.

It will be understood that a “true pressure” may be an actual, real time, instantaneous, and/or measured pressure of the breathing circuit (e.g., the medium-pressure breathing circuit).

It will be understood that the term “majority proportion” may refer to a proportion of the nominal pressure above half., i.e., 50% or more of the nominal pressure. For example, if the nominal pressure were 8 bar, then a majority proportion of the nominal pressure may be 4 bar or above.

The term “exceeds” in the context of the threshold, may include meeting and/or exceeding the threshold.

The cycle counter may comprise a bore in which the piston moves. The first side and the second side of the piston may be arranged on a head of the piston. The head may divide the bore into an ambient-pressure region at the ambient pressure and a breathing circuit region at the true pressure. The breathing circuit pressure region may be a medium-pressure region. The breathing circuit pressure region may be a high-pressure region.

The breathing circuit pressure region may be in communication (e.g., fluid communication) with the breathing circuit, such that gas in the breathing circuit may flow into the breathing circuit pressure region.

Where the breathing circuit pressure region is a medium-pressure region, the medium-pressure region may be in communication (e.g., fluid communication) with the medium-pressure breathing circuit, such that gas in the medium-pressure breathing circuit may flow into the medium-pressure region.

The breathing circuit pressure region may be supplied with breathing gas from the breathing circuit through a restricting orifice configured to limit a flow rate of breathing gas into the breathing circuit pressure region.

The restricting orifice may be configured to limit the flow rate of breathing gas from the breathing circuit into the breathing circuit pressure region to less than 0.1 ml/s at the nominal pressure. The restricting orifice comprises a diameter of less than 50 µm. For example, the restricting orifice may comprise a diameter of less than 40 µm, or less than 30 µm, or less than 20 µm, or less than 10 µm. The breathing circuit pressure region may comprise a volume of between 5 ml and 50 ml. For example, the breathing circuit region may comprise a volume of 20 ml.

The restricting orifice may be configured to cause a time delay in the true pressure of the breathing circuit pressure region exceeding the threshold when the breathing circuit is initially pressurised.

The restricting orifice may be configured to limit the flow rate of breathing gas into the breathing circuit pressure region such that it may take several minutes for the true pressure in the breathing circuit pressure region to exceed the threshold. The time delay may therefore be 1, 2, 3, 4, 5, or more minutes.

It will be appreciated that the term “initially pressurised” refers to a first or initial pressurisation of the breathing circuit to its nominal or working pressure(s) during an instance of use of the breathing apparatus. Before a breathing circuit is pressurised, the pressure therein may be at substantially ambient pressure. Once the breathing circuit is connected to a supply of pressurised breathing gas (such as a breathing gas cylinder), pressure inside the breathing circuit begins to increase.

The restricting orifice may restrict flow of breathing gas into the breathing circuit pressure region from the main breathing circuit to delay the true pressure in the breathing circuit pressure region from exceeding the threshold.

The threshold may correspond to at least 70% of the nominal pressure. The threshold may correspond to a difference in pressure between the nominal pressure the true pressure of between 0.5 bar and 3 bar or between 0.75 bar and 1.5 bar.

It will be appreciated that the threshold may correspond to a true pressure of less than 30% below the nominal pressure. The threshold may be met where the true pressure is above ambient pressure.

For a nominal pressure of 8 bar, the threshold may be met when the true pressure exceeds 6.5 bar. The threshold may be met when the true pressure exceeds 7 bar, or 7.5 bar.

A difference between the nominal pressure and the true pressure may be caused, at least in part, by intermittent consumption of breathing gas from the breathing circuit by a user breathing through a lung demand regulator connected to the breathing circuit.

The breathing circuit may comprise a lung demand regulator. A user may breathe through the lung demand regulator to be supplied with breathing gas from the breathing circuit during inhalation. During inhalation, while the breathing circuit is supplying the user with breathing gas, the true pressure in the breathing circuit temporarily decreases.

Each cycle of the piston between the minimum displacement and the maximum displacement may correspond to a breath taken by a user through a lung demand regulator connected to the breathing circuit.

The indicator may comprise a mechanical counter having an incrementing mechanism. The piston may be coupled to the incrementing mechanism to increment the mechanical counter each time the piston is displaced between the minimum displacement and the maximum displacement.

The incrementing mechanism may comprise a lever and/or a depressible plunger. A lever of the incrementing mechanism may provide additional leverage to enable the displacement of the piston (which may provide relatively little force) to actuate the incrementing mechanism (which may require more force). The incrementing mechanism may be engaged by the piston. The incrementing mechanism may be actuated by the piston. On actuation, the incrementing mechanism may increment the mechanical counter.

The indicator may comprise an alerting apparatus configured to transition from a non-alerting state to an alerting state when the counter is incremented beyond a counter threshold, optionally wherein the alerting apparatus is a colour changing alerting apparatus and/or an actuating alerting apparatus.

The alerting apparatus may be a non-electrical and/or non-electronic alerting apparatus. The alerting apparatus may be a mechanical and/or mechanical-only alerting apparatus.

The biasing element may be configured to urge the piston to the minimum displacement unless the true pressure exceeds the threshold. The biasing element may be a coiled spring.

The biasing element may be a compression spring that exerts a force against the first side of the piston. The biasing element may bias the piston towards the breathing circuit pressure region.

The biasing element may be an adjustable biasing element. That is to say, a force exerted by the biasing element may be variably to vary the threshold. The biasing element may be adjustable by a threaded rotatable tensioner.

A displacement range of the piston may be between 1 mm and 5 mm. A displacement range of the piston may be 1.5 mm.

According to a fourth aspect, there is provided a breathing circuit for a breathing apparatus comprising a lung demand regulator and cycle counter according to any of the first to third aspects.

According to a fifth aspect, there is provided a breathing apparatus comprising a breathing circuit according to the fourth aspect.

According to a sixth aspect, there is provided a breathing apparatus comprising a cycle counter according to any of the first to third aspects.

According to a seventh aspect, there is provided a piston apparatus comprising a piston and a biasing element. The piston may comprise a first side configured to be exposed to a true pressure in a breathing circuit of a self-contained breathing apparatus, the breathing circuit being configured to operate at a nominal pressure, and a second side configured to be exposed to an ambient pressure. The piston apparatus may comprise a biasing element configured to: permit the piston to move from a minimum displacement to a maximum displacement when the true pressure exceeds a threshold; and return the piston from the maximum displacement to the minimum displacement when the true pressure falls below the threshold. The threshold may be a majority proportion of the nominal pressure.

It will be appreciated that the term “breathing circuit” may refer to an entire breathing circuit (e.g., of a breathing apparatus) or to a portion of a breathing circuit designed to operate at a particular pressure (e.g., medium-pressure). That is, reference to the term “breathing circuit” in the various aspects described above is interchangeable with the term “medium-pressure breathing circuit”. Similarly, the term “breathing circuit” is equally interchangeable with the term “high-pressure breathing circuit”.

Reference to the term “cycle counter” in the various aspects described above is interchangeable with the term “medium-pressure cycle counter”. Similarly, the term “cycle counter” is equally interchangeable with the term “high-pressure cycle counter”.

Reference to the term “breathing circuit pressure region” in the various aspects described above is interchangeable with the term “medium-pressure region”. Similarly, the term “breathing circuit pressure region” is equally interchangeable with the term “high-pressure region”. Simply put, the cycle counters disclosed herein may be suitable for measuring pressure cycles in a medium-pressure breathing circuit and/or in a high-pressure breathing circuit.

The terms “medium-pressure” and “high-pressure” shall be given their understood meanings in the art, as described above.

### BRIEF DESCRIPTION OF THE DRAWINGS

Arrangements of the disclosure will now be described, by way of example, and with reference to the accompanying drawings, in which:

FIG. 1 schematically shows a breathing apparatus according to an embodiment;

FIG. 2 shows a graph of variations of medium pressure in a medium-pressure breathing circuit according to an embodiment;

FIG. 3 schematically shows a medium-pressure cycle counter according to an embodiment;

FIGS. 4A and 4B schematically show cross-sectional views of a piston apparatus according to an embodiment; and

FIGS. 5A and 5B schematically show cross-sectional views of a piston apparatus according to an embodiment.

### DETAILED DESCRIPTION OF THE DRAWINGS

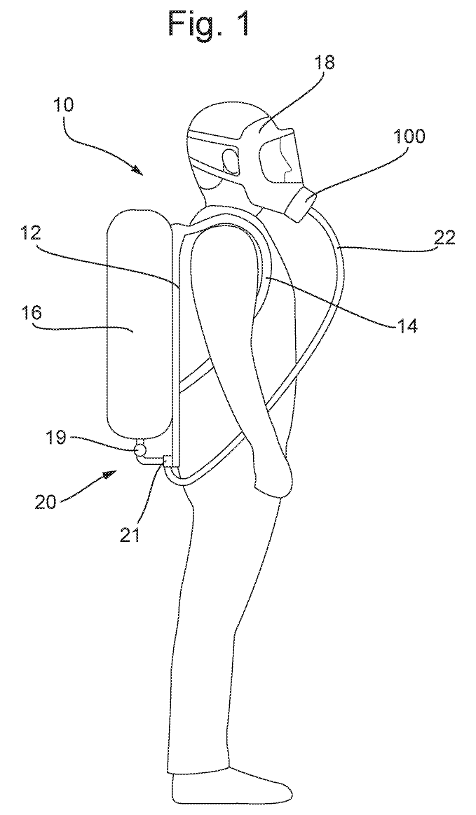

With reference to FIG. 1, an example breathing apparatus 10 is shown. The breathing apparatus 10 is a self-contained breathing apparatus (SCBA) and comprises a support frame or backplate 12, straps 14 for securing the SCBA to a user, a breathing gas cylinder 16, a face mask 18, a lung demand regulator 100 connectable to the face mask 18, and a pneumatics system 20 for delivering breathing gas from the cylinder 16 via a flexible conduit or hose 22 to the lung demand regulator 100, to thereby deliver breathing gas to the user wearing the face mask 18 on demand. The pneumatics system 20 is connected to the breathing gas cylinder 16 by a valve 19. The breathing apparatus 10 may further comprise other components or systems which are not shown, including but not limited to an electrical system, a monitoring system, or a communications system. The lung demand regulator 100 is referred to as the regulator 100 throughout.

In this illustrated arrangement, the breathing apparatus 10 is a self-contained breathing apparatus (SCBA), but it should be understood that the lung demand regulator may also have applications in other types of breathing apparatus, such as self-contained underwater breathing apparatus (SCUBA) and emergency escape breathing apparatus.

The pneumatics system 20 comprises a first-stage pressure reducer 21 which reduces the pressure of the breathing air from the cylinder 16 which may be stored at a high pressure (e.g., several hundred bar), to an intermediate or medium pressure for provision to the regulator 100 via the hose 22. The medium pressure may be too high for the breathing gas to be provided directly to the user to breathe. Therefore, the regulator 100 may further comprise a second-stage pressure reducer which further reduces the medium pressure of the breathing gas to a low pressure suitable for provision to the user to breathe.

In other words, the breathing gas stored at high pressure is expanded down to a medium pressure by the first-stage pressure reducer. The breathing gas at medium pressure is then expanded down to a low pressure by a second stage pressure reducer (e.g., regulator 100) to be delivered to a user. Therefore, the breathing apparatus 10 comprises three “circuits” – a high-pressure circuit, a medium-pressure breathing circuit, and a low-pressure circuit.

The parts of the pneumatics system 20 which direct the flow of supplied breathing gas to, and sometimes from, the user are together known as the breathing circuit. Breathing circuits may be open, closed, or semi-closed, depending on whether breathing gas is recycled. It is only in the case of closed systems where the breathed gas completes a full circuit (i.e., returns back to its origin). Breathing apparatus are routinely classified as "open circuit" when there is no recycling of exhaled gas, and therefore no complete circuit in the more general sense.

The portion of the breathing circuit between the breathing gas cylinder 16 and the first-stage pressure reducer 21 may be known as the high-pressure breathing circuit, as it contains the highest pressure gas in the system (usually around between 300 bar and 400 bar). The portion of the breathing circuit between the first-stage pressure reducer 21 and the second-stage pressure reducer may be known as the medium-pressure breathing circuit, as it contains breathing gas that has been expanded down to an intermediate or medium pressure. The portion of the breathing circuit downstream of the second-stage pressure reducer may be known as the low-pressure breathing circuit, as it contains the lowest pressure breathing gas in the system.

Consequently, “medium pressure” is a term of art which is well understood in the field of breathing apparatus, which is used to refer to a portion of a breathing apparatus 10 which operates at an intermediate or medium pressure between other portions of the breathing apparatus 10 which operate at a high pressure and a low pressure respectively. Equally, “high pressure” is also a term of art which is well understood in the field of breathing apparatus, which is used to refer to a portion of a breathing apparatus 10 which operates at the highest pressure in the breathing apparatus 10.

Generally, the pressure of breathing gas in the medium-pressure breathing circuit (i.e., the medium pressure) is around 5-10 bar, for example, around 7 bar or 8 bar. This pressure may be referred to as the nominal pressure. This is significantly lower than the high pressure of the high-pressure breathing circuit, which is at around 300-400 bar. It is also more than the breathable low pressure of the low-pressure breathing circuit, which is typically around 1 bar.

For the purpose of brevity, the present disclosure is described primarily in relation to the medium-pressure breathing circuit. However, it will be appreciated that the principles described herein are equally applicable to (and are indeed envisaged as apply to) the high-pressure breathing circuit of a breathing apparatus. Nevertheless, the disclosure, as it relates to the high-pressure breathing circuit, will be described in more detail towards the end of this disclosure.

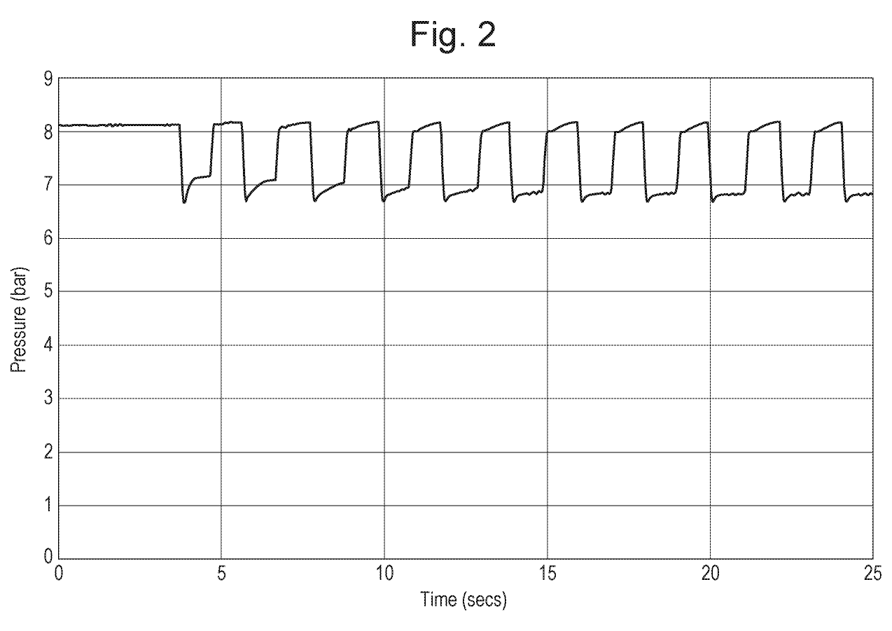

FIG. 2 shows a graph of the pressure in the medium-pressure breathing circuit of the breathing apparatus 10 over time. Initially, between 0 and approximately 3.5 seconds, the pressure is steady at just over 8 bar. Then, at around 3.5 seconds, the pressure sharply decreases to around 6.7 bar. The pressure in the medium-pressure breathing circuit then increases returning back to the initial pressure of 8 bar at around 5 seconds. As shown, this cycle repeats nine more times over the proceeding 20 seconds.

The waveform shown in FIG. 2 represents the change in pressure in the medium-pressure breathing circuit as a user breathes through the regulator 100 of the breathing apparatus 10. As the user inhales, the second-stage pressure reducer of the regulator 100 opens, allowing breathing gas at medium pressure from the medium-pressure breathing circuit to flow into the regulator 100. This causes a drop in pressure in the medium-pressure breathing circuit, as shown. In response to the medium pressure dropping, the first-stage pressure reducer 21 opens, thereby allowing high pressure breathing gas to flow into the medium-pressure breathing circuit. As the user exhales, the second-stage pressure reducer closes and the breathing gas flowing into the medium-pressure breathing circuit returns the medium-pressure breathing circuit to its nominal pressure.

It will therefore be appreciated that each breath taken by a user causes a pressure perturbation in the medium-pressure breathing circuit. It will also be appreciated that recording the number of breathes taken by the user through the breathing apparatus 10 provides a useful estimation for the wear experienced by the breathing apparatus 10, and therefore when the breathing apparatus 10 should be serviced. Therefore, rather than relying on a fixed period of time between services (which does not take into account the actual amount of usage of the breathing apparatus 10), it is possible to determine when a service should take place based on the number of breaths taken through the breathing apparatus 10. A typical breathing gas cylinder 16 can store enough breathing gas for a user to take around 1800 breaths. A breathing gas cylinder 16 may typically be used (drained from full to empty) around 900 times per year. Therefore, a typical breathing apparatus 10 may experience wear corresponding to around 1.6 million breaths per year (1800 breaths per use multiplies by 900 uses per year).

The present disclosure provides apparatus and methods for counting, for example, the number of breaths taken by a user through a breathing apparatus 10 so that maintenance of the breathing apparatus 10 can be more accurately scheduled. More specifically, the present disclosure relates to apparatus and methods aimed at indicating when a breathing apparatus system may need to be inspected and/or serviced. In particular, the present disclosure relates to a cycle counter configured to measure pressure cycles within a breathing circuit of a self-contained breathing apparatus. The breathing circuit may be configured to operate at a nominal pressure (e.g., a working pressure). The cycle counter may comprise: a piston having a first side exposed to a true pressure in the breathing circuit and a second side exposed to an ambient pressure; a biasing element; and an indicator. The biasing element may be configured to: permit the piston to move from a minimum displacement to a maximum displacement when the true pressure exceeds a threshold; and return the piston from the maximum displacement to the minimum displacement when the true pressure falls below the threshold. The threshold may be a majority proportion of the nominal pressure. The indicator may be configured to increment a counter each time the piston cycles between the minimum displacement and the maximum displacement.

Some embodiments of the present disclosure relate to a medium-pressure cycle counter configured to measure pressure cycles within a medium-pressure breathing circuit of a self-contained breathing apparatus. The medium-pressure breathing circuit may be configured to operate at a nominal pressure (e.g., a working pressure). The medium-pressure cycle counter may comprise: a piston having a first side exposed to a true pressure in the medium-pressure breathing circuit and a second side exposed to an ambient pressure; a biasing element; and an indicator. The biasing element may be configured to: permit the piston to move from a minimum displacement to a maximum displacement when the true pressure exceeds a threshold; and return the piston from the maximum displacement to the minimum displacement when the true pressure falls below the threshold. The threshold may be a majority proportion of the nominal pressure. The indicator may be configured to increment a counter each time the piston cycles between the minimum displacement and the maximum displacement.

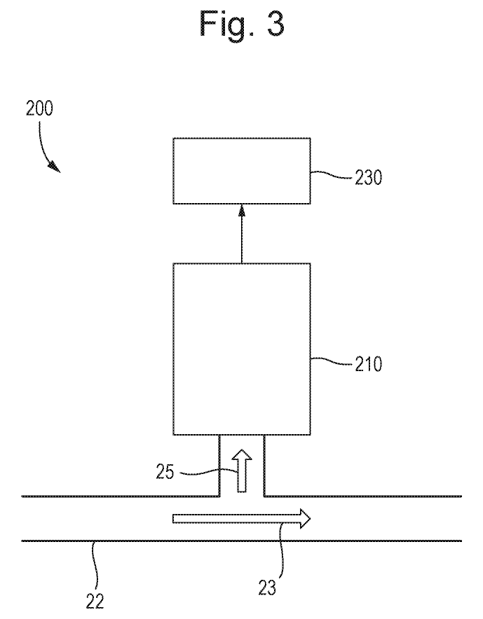

FIG. 3 depicts a schematic diagram of an embodiment of the present disclosure. The medium-pressure cycle counter 200 (referred to as the cycle counter 200 throughout) comprises a piston apparatus 210 and an indicator 230. In this embodiment, the piston apparatus 210 is fluidly connected to the hose 22 of the pneumatics system 20 such that the piston apparatus 210 is exposed to the medium pressure of the medium-pressure breathing circuit. In other embodiments, another component of the pneumatics system 20 (such as the first-stage pressure reducer 21) may connect the piston apparatus 210 to the medium-pressure breathing circuit. As shown, the medium pressure breathing gas mainly flows along the hose in the direction of the first arrow 23 from the first-stage pressure reducer towards the second-stage pressure reducer. However, some of the medium pressure breathing gas moves in the direction of the second arrow 25 where it enters the piston apparatus 210, thereby enabling the piston apparatus 210 to experience the medium pressure of the breathing gas. The piston apparatus 210 is coupled to the indicator 230 (for example, by a mechanical linkage) as will be described in more detail below.

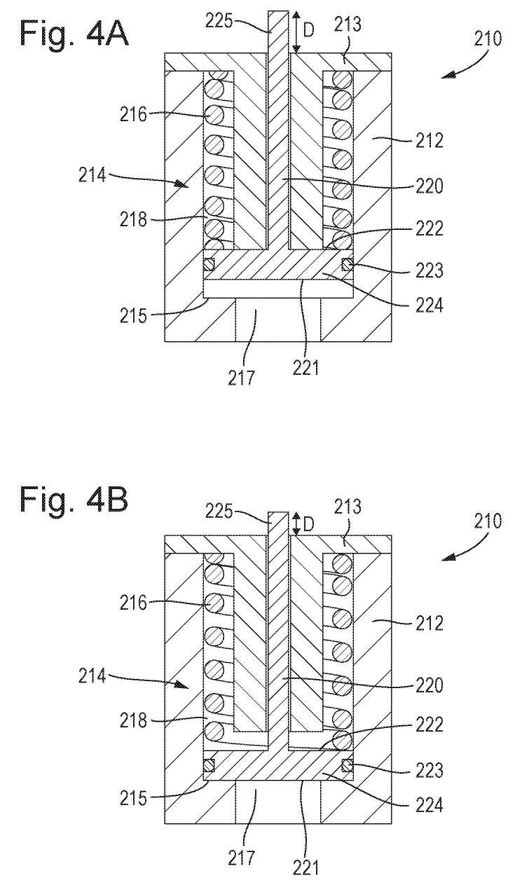

Turning to FIG. 4A, a cross-sectional view of the piston apparatus 210 of FIG. 3 is shown. The piston apparatus 210 comprises a body 212 defining a bore 214 in which a piston 220 is retained. The piston 220 is retained within the body 212 by a shoulder 215 of the bore 214 as well as a guide element 213. The guide element 213 also centres the piston 220 to ensure it moves axially within the bore 214.

The piston 220 comprises a head 224 which is configured to move within the bore 214. The piston 220 has a first side 221 which is exposed to the medium pressure breathing gas of the medium-pressure breathing circuit. The piston 220 has a second side 222 which is exposed to an ambient pressure of the ambient environment (e.g., atmospheric pressure). The head 224 comprises a sealing element 223 which prevents breathing gas from escaping from the medium-pressure breathing circuit between the body 212 the head 224.

The head 224 divides the bore 214 into a medium-pressure region 217 and an ambient pressure region 218. The medium-pressure region 217 is in fluid communication with the medium-pressure breathing circuit and is therefore exposed to the medium pressure breathing gas and the effects thereof. The ambient pressure region 218 is exposed to the ambient pressure.

The piston 220 also comprises an end portion 225 at an opposite end of the piston 220 to the head 224. The piston 220 is constrained to move within the body 212 between a minimum displacement position and a maximum displacement position, so named because of the displacement D of the end portion 225 from the body 212. FIG. 4A shows the piston in the maximum displacement position where the end portion 225 extends to a maximum extent from the body 212. The minimum displacement of the piston 220 is set by the shoulder 215, while the maximum displacement of the piston 220 is set by the guide element 213.

The piston apparatus 210 also comprises a biasing element 216. In this embodiment, the biasing element 216 is a compression spring configured to exert a biasing force against the second side 222 of the piston 220.

As described above, the pressure of the breathing gas in the medium-pressure breathing circuit can vary, for example, in response to a user inhaling. As a result, the pressure in the medium-pressure breathing circuit can vary between slightly above and/or slightly below a nominal pressure. The actual pressure within the medium-pressure breathing circuit is referred to as the true pressure and may be the same as or different to the nominal pressure depending on whether, for example, a user is inhaling.

When the true pressure of the breathing gas in the medium-pressure breathing circuit exceeds a threshold, the force exerted by the breathing gas on the first side 221 of the piston 220 overcomes the biasing force of the biasing element 216 to permit the piston 220 to move from the minimum displacement to the maximum displacement. On the other hand, when the true pressure of the breathing gas in the medium-pressure breathing circuit falls below the threshold, the biasing force exerted by the biasing element 216 overcomes the force exerted by the breathing gas to thereby return the piston to the minimum displacement.

FIG. 4B shows the piston apparatus 210 with the piston 220 minimally displaced. As shown, the displacement distance D of the end portion 225 of the piston 220 is significantly less than in FIG. 4A.

It will be understood that the piston 220 is able to reciprocate between the minimum displacement and the maximum displacement in response to perturbations of the medium pressure. In order for the piston 220 to reciprocate as described, the true pressure must fall below the threshold before exceeding the threshold again. The threshold is relative to the nominal pressure of the medium-pressure breathing circuit. That is, the threshold is a pressure corresponding to a proportion of the nominal pressure. In particular, the threshold is a majority proportion of the nominal pressure. In some embodiments, the threshold may correspond to at least 70% of the nominal pressure. For example, for a nominal pressure of 8 bar, the threshold may be 5.6 bar. In some embodiments, the threshold may be 6.5 bar (around 80%). It will be appreciated that, as the threshold is a majority proportion of the nominal pressure, the threshold will generally be several bar above ambient pressure.

In some embodiments, the threshold may be a first threshold, and the true pressure may be required to exceed a second threshold before the piston can move from the minimum displacement to the maximum displacement. The second threshold may be higher than the first threshold. For example, if the first threshold is 70% of the nominal pressure, the second threshold may be 90% of the nominal pressure.

As noted previously in relation to FIG. 3, the piston apparatus 210 is coupled to an indicator 230. In some embodiments, the indicator 230 comprises a counter. The indicator 230 may be configured to increment the counter in response to each cycle of the piston 220 between the minimum displacement and the maximum displacement. In this way, the counter may record the number of pressure perturbations within the medium-pressure breathing circuit, and therefore, for example, the number of breaths taken by a user.

The indicator 230 may comprise an incrementing mechanism to which the piston 220 is coupled. Each movement cycle of the piston 220 may impart a force to the incrementing mechanism which in turn increments the counter. In some embodiments, the incrementing mechanism may comprise a linkage such as a lever which amplifies the force of the piston 220 sufficiently to actuate the counter.

The counter may be a mechanical counter and may comprise a mechanical display. For example, the counter may comprise an eight digit decimal mechanical display capable of displaying an eight digit decimal number. The mechanical display may be readable by a user to identify how may breaths have been taken using the breathing apparatus 10. Once the number of breaths exceeds a predefined threshold (e.g., 1.6 million breaths), the user will know that the breathing apparatus 10 requires servicing. The counter may comprise a reset function with which the mechanical display can be reset to zero. Once a service of the breathing apparatus 10 has been carried out, the counter may be reset to zero so that the number of breaths taken since the service can be recorded.

The indicator 230 may comprise an alerting apparatus that transitions from a non-alerting state to an alerting state once the counter passes a threshold. For example, the alerting apparatus may be a colour changing alerting apparatus which changes colour when the counter passes a specified number. In some embodiments, the alerting apparatus is an actuating or “pop-up” alerting apparatus which actuates to show the user that the threshold count has been reached. The alerting apparatus may be resettable to move the alerting apparatus from the alerting state back to the non-alerting state.

In this way, each use of the breathing apparatus 10 is automatically recorded and a user is automatically alerted when a threshold is reached. There is no need for an electrical or electronic system to monitor for uses, which would need to be powered by a power supply. Instead, embodiments of the present disclosure are powered by the pressure (and the variations thereof) inherently present in the system when in use.

The recording of breaths taken by a user, as provided by the cycle counter 200, could also be used for analytical purposes. For example, the number of breaths taken by a user during a response to an emergency situation could be used to infer the exertion of the user and whether they are safe to re-enter the emergency situation or require recovery time.

As noted above, in some embodiments, the piston apparatus 210 may be connected to a high-pressure breathing circuit. In such embodiments, the piston 220 may move from the minimum displacement to the maximum displacement when the true pressure in the high-pressure breathing circuit exceeds a threshold. The piston 220 may move from the maximum displacement back to the minimum displacement when the true pressure in the high-pressure region falls below the threshold.

Where the piston apparatus 210 is connected to a high-pressure breathing circuit, the threshold may be, for example at least 50-90% of the nominal pressure in the high-pressure breathing circuit. In some embodiments, where the nominal pressure in the high-pressure breathing circuit is 300 bar, the threshold may be 280 bar. That is to say when the true pressure in the high-pressure breathing circuit is less than 280 bar, the piston apparatus 210 may be in the minimum displacement position. Then, once the true pressure exceeds 280 bar, the piston apparatus 210 may move from the minimum displacement to the maximum displacement.

One implementation of such embodiments may be to count the number of pressurisations of the high-pressure breathing circuit. Once a high-pressure breathing gas supply (e.g., a breathing gas cylinder) is connected to the high-pressure breathing circuit, the true pressure in the high-pressure breathing circuit beings to increase. Once the true pressure increases past the threshold, this will be counted as a pressurisation.

Thus, it will be appreciated that the piston apparatus 210 of FIGS. 4A and 4B is applicable for use in both a high-pressure breathing circuit and a medium-pressure breathing circuit.

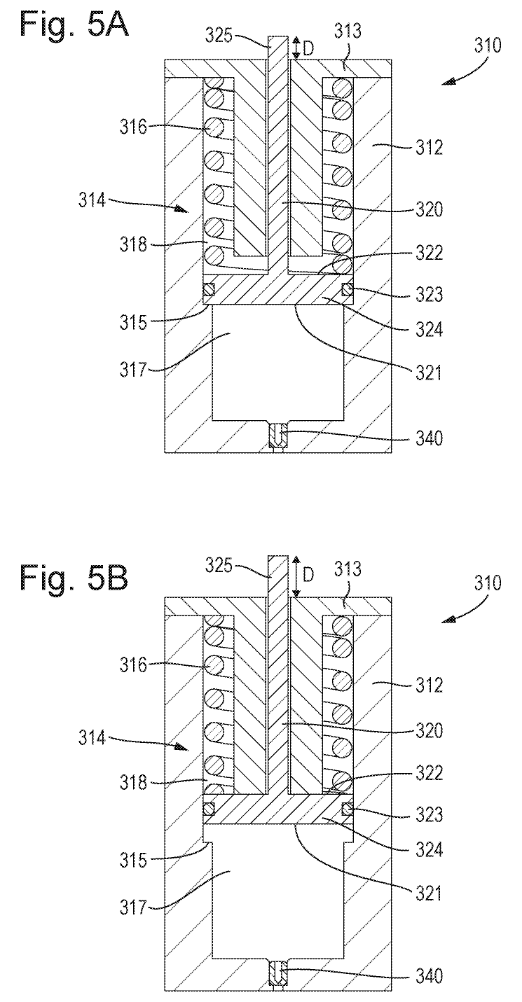

FIG. 5A shows a similar piston apparatus 310 to the piston apparatus 210 of FIGS. 4A and 4B. However, rather than reciprocating according to perturbations caused by each user inhalation, the piston 320 of this embodiment is displaced within the body 312 during each operational pressurisation of the medium-pressure breathing circuit. To achieve this, the piston 320 may comprise a head 324 which separates a medium-pressure region 317 from an ambient pressure region 318 as before, however medium-pressure region 317 may be significantly larger than in the previous embodiment. Further, the piston apparatus 310 comprises a restricting orifice 340 at an opening to the medium-pressure region 317.

Before the medium-pressure breathing circuit is pressurised (i.e., before the breathing apparatus 10 is prepared for use), the true pressure within the medium-pressure breathing circuit and within the medium-pressure region 317 is at ambient pressure. Therefore, in this state the true pressure in the medium-pressure region 317 is below the threshold and so the piston 320 is minimally displaced within the bore 314 of the body 312 (as shown in FIG. 5A). The biasing element 316 maintains the piston 320 in the minimally displaced position while the true pressure in the medium-pressure region 317 remains below the threshold.

Once a high pressure supply of breathing gas (such as a cylinder 16) is connected to the breathing apparatus 10 and the valve 19 is opened, the first-stage pressure reducer 21 will quickly fill the medium-pressure breathing circuit the breathing gas at the nominal pressure (e.g., 8 bar). However, due to the restricting orifice 340, the pressure in the medium-pressure region 317 will increase far slower than the pressure in the medium-pressure breathing circuit. That is, the restricting orifice 340 limits a flow rate of breathing gas into the medium-pressure region 317 such that the true pressure in the medium-pressure region 317 is delayed from reaching the nominal pressure.

In some embodiments, the medium-pressure region 317 may comprise a volume of around 20 ml and the restricting orifice 340 may comprise a circular shape with a diameter of around 30 µm. As a result, the flow of breathing gas into the medium-pressure region 317 from the medium-pressure breathing circuit may be limited to less than 0.1 ml/s. This may result in a delay of several minutes (e.g., five minutes) for the true pressure in the medium-pressure region 317 to exceed the threshold. The parameters of the restricting orifice 340 are chosen such that the delay is longer than a standard leak test duration (e.g., twice as long). Breathing apparatus are routinely checked for leaks by pressurising the system briefly and checking that the system holds the expected pressure. These checks typically last up to a couple of minutes, after which time the system is depressurised. By ensuring that the restricting orifice 340 causes a delay of longer than this time, the piston 320 will only move when the medium-pressure breathing circuit is pressurised for an extended period – indicating that the system is in use by a user rather than merely undergoing a leak test.

After the delay, once the true pressure in the medium-pressure region 317 exceeds the threshold, the force of the breathing gas acting on the first side 321 of the head 324 overcomes the biasing force acting on the second side 322 of the head 324 the piston 320, resulting in the head 324 moving off of the shoulder 315 until it contacts the guide element 313, where it is maximally displaced. FIG. 5B shows the piston apparatus 310 in the maximally displaced position where the end portion 325 extends further from the body 312 than in FIG. 5A.

After use, once the breathing gas in the medium-pressure breathing circuit dissipates and the medium-pressure breathing circuit returns to ambient pressure, the breathing gas in the medium-pressure region 317 will also slowly dissipate through the restricting orifice 340 and the piston 320 will eventually return to the minimally displaced position.

As with the piston apparatus 210 of FIGS. 4A and 4B, the piston apparatus 310 of FIGS. 5A and 5B can be coupled to an indicator 230. However, when coupled to the piston apparatus 310 of FIGS. 5A and 5B, the indicator 230 increments a counter each time the medium-pressure breathing circuit is pressurised for at least a specified period of time (e.g., 5 minutes or whatever the delay caused by the restricting orifice 340 corresponds to). In this way, the indicator 230 only counts pressurisations resulting from genuine operational use of the breathing apparatus 10, rather than pressurisations resulting from a brief pressurisations, such as during a quick leak test. Therefore, the counter is not unnecessarily incremented when the breathing apparatus 10 has not undergone significant wear resulting from an operational use. Thus, the breathing apparatus 10 is not serviced more frequently than is necessary – saving time for service engineers and reducing downtime of equipment.

As with the piston apparatus 210 of FIGS. 4A and 4B, the piston apparatus 310 of FIGS. 5A and 5B can be connected to a high-pressure breathing circuit rather than a medium-pressure breathing circuit. Doing so enables pressurisations of the high-pressure breathing circuit to be counted. However, importantly, only pressurisations lasting for at least the time duration of the time delay caused by the restricting orifice will be counted. As a result, shorter pressurisations of the high-pressure breathing circuit (e.g., resulting from a short leak check of the breathing circuit) are not counted. This means that only longer duration pressurisations (which lead to wear of the breathing circuit components) contribute to the overall pressurisations count.

It will be appreciated that the cycle counter 200 described herein does not permit breathing gas to escape from the medium-pressure breathing circuit into the ambient environment. Specifically, the sealing element 223, 323 prevents breathing gas from escaping. However, in some embodiments, the cycle counter 200 may vent a small portion of breathing gas, for example during each reciprocal movement of the piston 220, 320.

The cycle counter 200 described herein may be a modular component that is capable of being connected to a breathing apparatus 10. For example, the cycle counter 200 may comprise a connector (e.g., a quick release or bayonet style) connector that enables the cycle counter 200 to be connected to the medium-pressure breathing circuit. In some embodiments, the cycle counter 200 may be connected to a port of the first-stage pressure reducer 21 which is in fluid communication with the medium-pressure breathing circuit.

It will be appreciated by those skilled in the art that although the invention has been described by way of example, with reference to one or more exemplary embodiments, it is not limited to the disclosed embodiments and alternative embodiments could be constructed without departing from the scope of the invention as defined by the appended claims.

1. A cycle counter configured to measure pressure cycles within a breathing circuit of a self-contained breathing apparatus, the breathing circuit being configured to operate at a nominal pressure, the cycle counter comprising:
a piston having a first side exposed to a true pressure in the breathing circuit and a second side exposed to an ambient pressure;
a biasing element configured to:
permit the piston to move from a minimum displacement to a maximum displacement when the true pressure exceeds a threshold; and
return the piston from the maximum displacement to the minimum displacement when the true pressure falls below the threshold;
wherein the threshold is a majority proportion of the nominal pressure; and
an indicator configured to increment a counter each time the piston cycles between the minimum displacement and the maximum displacement.

2. The cycle counter of claim 1, wherein:
the cycle counter is a medium-pressure cycle counter and the breathing circuit is a medium-pressure breathing circuit; or
the cycle counter is a high-pressure cycle counter and the breathing circuit is a high-pressure breathing circuit.

3. The cycle counter of claim 1 further comprising a bore in which the piston moves, wherein the first side and the second side of the piston are arranged on a head of the piston , the head dividing the bore into an ambient-pressure region at the ambient pressure and a breathing circuit pressure region at the true pressure.

4. The cycle counter of claim 3, wherein the breathing circuit pressure region is supplied with breathing gas from the breathing circuit through a restricting orifice configured to limit a flow rate of breathing gas into the breathing circuit pressure region.

5. The cycle counter of claim 4 wherein the restricting orifice is configured to limit the flow rate of breathing gas from the breathing circuit into the breathing circuit pressure region to less than 0.1 ml/s at the nominal pressure and wherein the restricting orifice comprises a diameter of less than 50 µm.

6. The cycle counter of claim 4, wherein the restricting orifice is configured to cause a time delay in the true pressure of the breathing circuit pressure region exceeding the threshold when the breathing circuit is initially pressurised.

7. The cycle counter of claim 1, wherein the threshold corresponds to at least 70% of the nominal pressure.

8. The cycle counter of claim 1 wherein the threshold corresponds to a difference in pressure between the nominal pressure the true pressure of between 0.75 bar and 1.5 bar.

9. The cycle counter of claim 1, wherein when the nominal pressure is 8 bar, the threshold is met when the true pressure exceeds 6.5 bar.

10. The cycle counter of claim 1, wherein:
a difference between the nominal pressure and the true pressure is caused, at least in part, by intermittent consumption of breathing gas from the breathing circuit by a user breathing through a lung demand regulator connected to the breathing circuit.

11. The cycle counter of claim 1, wherein:
each cycle of the piston between the minimum displacement and the maximum displacement corresponds to a breath taken by a user through a lung demand regulator connected to the breathing circuit.

12. The cycle counter of claim 1, wherein the indicator comprises a mechanical counter having an incrementing mechanism, and wherein the piston is coupled to the incrementing mechanism to increment the mechanical counter each time the piston is displaced between the minimum displacement and the maximum displacement.

13. The cycle counter of claim 1, wherein the indicator comprises an alerting apparatus configured to transition from a non-alerting state to an alerting state when the counter is incremented beyond a counter threshold.

14. The cycle counter of claim 13 wherein the alerting apparatus is a colour changing alerting apparatus and/or an actuating alerting apparatus.

15. The cycle counter of claim 1, wherein the biasing element is configured to urge the piston to the minimum displacement unless the true pressure exceeds the threshold and wherein the biasing element is a coiled spring.

16. The cycle counter of claim 1, wherein a displacement range of the piston is between 1 mm and 5 mm.

17. A breathing circuit for a breathing apparatus comprising a lung demand regulator and a cycle counter according to claim 1.

18. The breathing circuit of claim 17 wherein the breathing circuit is a medium-pressure breathing circuit.

19. A breathing apparatus comprising a breathing circuit according to claim 17.

20. A breathing apparatus comprising a cycle counter according to claim 1.
